(19) United States
(12) Patent Application Publication
(10) Pub. No.: US 2015/0321270 A1
(43) Pub. Date: Nov. 12, 2015

(54) CO-MOVING HYDRAULIC SHEARS WITHOUT STAND

(71) Applicant: SMS SIEMAG AG, Düsseldorf (DE)

(72) Inventors: Matthias BEUTER, Bad Berleburg (DE); Bernhard EHLS, Hilchenbach (DE)

(73) Assignee: SMS SIEMAG AKTIENGESELLSCHAFT, Düsseldorf (DE)

(21) Appl. No.: 14/655,604

(22) PCT Filed: Dec. 23, 2013
(86) PCT No.: PCT/EP2013/077961

§ 371 Date: Jun. 25, 2015

(30) Foreign Application Priority Data
Dec. 28, 2012 (DE) 10 2012 224 532.4

(51) Int. Cl. B23D 15/04; B23D 25/08; B23D 15/06

(52) U.S. Cl. CPC B23D 15/04; B23D 15/06; B23D 25/08

(57) ABSTRACT

A shear, in particular a cross-cutting shear, for cutting flat material, including a upper blade support and a lower blade support, at least the upper blade support or the lower blade support being reciprocatingly displaceably guided and being displaceable by at least one adjustment device relative to the other respective blade support. The displaceable blade support is guided by the adjustment device and the adjustment device is designed so that it absorbs all the cutting forces and transversal forces.

The invention pertains to a shear for cutting flat material according to the introductory clause of claim 1.

In cases where discontinuously or continuously produced strips or sheets are produced, called “flat material” in the following, such those which as are produced during rolling, for example, it is known that the flat material can be cut into more manageable pieces for further processing. For this purpose, cutting devices in the form of shears, for example, are used.

In the case of a shear, the cutting gap usually has an optimal, specific value for a certain material of a given thickness. To ensure a clean cut, this value must remain constant over the entire cutting distance. It may therefore not become larger under the effect of the resultant forces, because otherwise the quality or cleanness of the cut will be unsatisfactory, and at the same time the blades will wear down more quickly.

To avoid a change in the cutting gap, guide elements are used, which allow the participating blades to move in the cutting direction. At the same time, however, these guide elements offer the maximum possible resistance to any other movements, so that movements which may be undesirable such as the bending of the support structure under the forces arising during the cutting operation can be prevented.

A shear of the class in question is known from DE 43 36 626 C2, which comprises a rigidly mounted upper blade support and a lower blade support capable of moving relative to the upper support. The powerful cutting forces which are required are introduced mechanically by means of an adjusting drive, which acts on the lower blade support by way of a worm gear unit. The forces resulting from the cutting forces introduced into the sheet require stable guidance of the blades with respect to each other, because the blades tend to move away from each other under these forces, which thus increases the size of the cutting gap, i.e., the distance between the upper blade and the lower blade. The guide elements for the movable lower blade support are configured as solid, round bars, which are able to absorb the transverse forces developing during the cutting process. The separation between the adjusting drive and the guide elements leads to the disadvantage that considerable effort is required to construct the device, which must also have relatively large dimensions, leading in addition to increased cost.

A shear is also known from JP 07 223109 A, in which a movable upper blade support is moved relative to a stationary lower blade support by hydraulic cylinders. An additional guide mechanism is provided to give the movable upper blade support precise guidance.

In the case of flat material produced discontinuously, a stationary installation of the shear to be used is sufficient. If the flat material is being conveyed continuously, it is necessary for the shear to move at the same speed as the strip, so that the flat material can be cut transversely to the feed direction. As described in DE 2 057 751 A, the flat material itself can serve as a drive to move the shear along with the flat material. Alternatively, the cross-cutting shear can be accelerated by a hydraulic piston, as described in DE 2 739 327 A1.

The invention is therefore based on the goal of avoiding the disadvantages of a complicated stand structure described above and to simplify the construction required for satisfactory functioning of a shear for flat material.

This goal is achieved according to the invention by a shear with the features of claim 1. Advantageous elaborations of the invention are defined in the dependent claims.

A shear according to the invention serves to cut flat material and comprises an upper blade support and a lower blade support, wherein at least the upper blade support or the lower blade support is guided with freedom to move up and down. The movable blade support can be moved relative to the other blade support by means of at least one adjusting device, wherein the movable blade support is guided by the adjusting device. In addition, the adjusting device is configured in such a way that it absorbs all the cutting and transverse forces.

The invention is based on the essential realization that the adjusting device can serve not only to move but also to guide the movable blade support during its up and down movements, wherein the adjusting device absorbs all of the occurring cutting and transverse forces. Expressed differently, the adjusting device takes over the additional task of a stand, which guides the blade support. Thus the adjusting device fulfills a double function, which is associated with the advantages of fewer components and more compact dimensions. Additional advantages consist in cost savings with respect to the production of the shear and its installation and maintenance.

To construct the shear so that it will operate reliably, it is important for both the adjusting device and the other components of the shear to be bigger and stronger than standard, commercially available elements. This will make it possible for the adjusting device to take over the double function described above.

In an advantageous elaboration of the invention, the adjusting device can be configured as a hydraulic cylinder. The piston rod of such a hydraulic cylinder comprises at least the dimensions of conventionally known guide elements in the form of, for example, round bars. The bearings of the piston rod of the hydraulic cylinder are also more-or-less similar in design to those of the original guide elements.

According to another embodiment, it is possible for the adjusting device to be configured as a mechanical system, which converts a rotational movement into a linear movement by means of a crankshaft with a connecting rod or other suitable means. As a result, the movable blade support can be moved or driven up and down relative to the other blade support.

The transverse forces arising during the cutting operation can be advantageously absorbed by the plain or roller bearings provided for the adjusting device.

An exemplary embodiment of the invention is described in greater detail below on the basis of schematically simplified drawings:

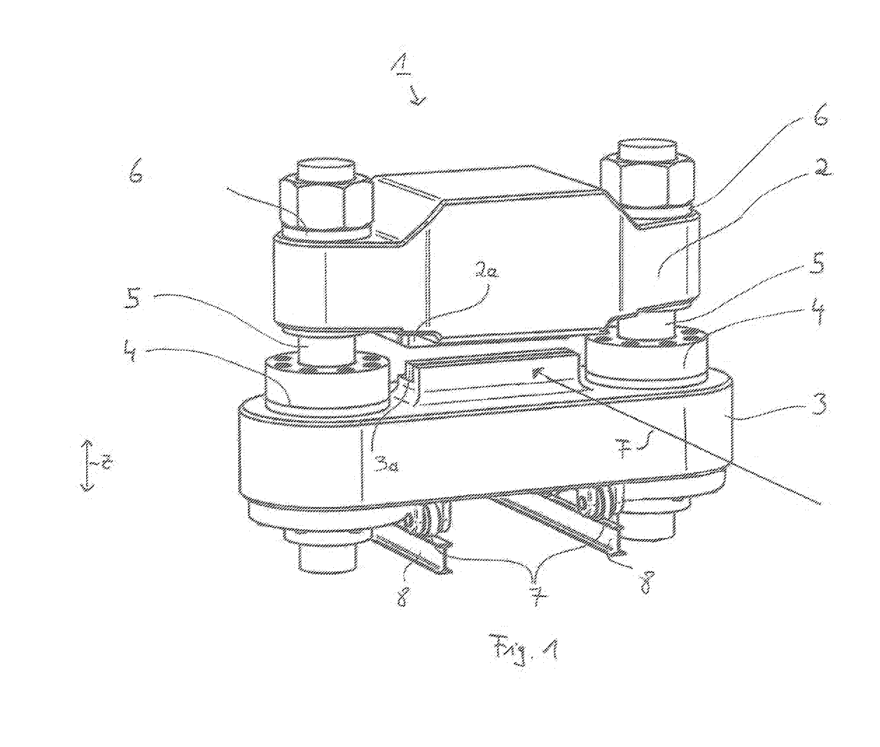

FIG. 1 shows a perspective view of a shear according to the invention; and

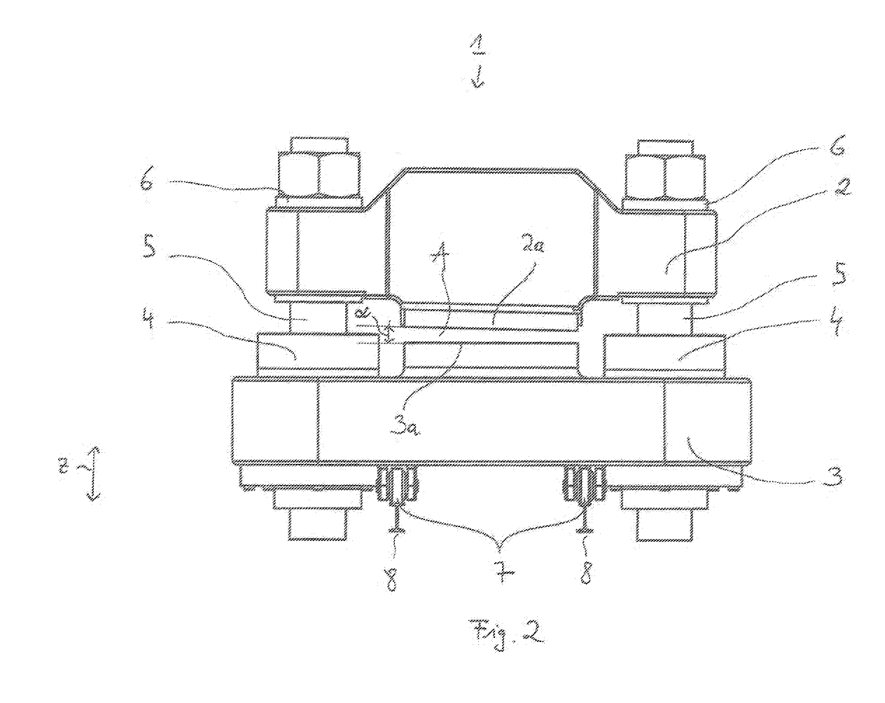

FIG. 2 shows a side view, from the front, of the shear of FIG. 1.

FIG. 1 shows a perspective view of a shear 1 according to the invention. The shear 1 comprises an upper blade support 2 and a lower blade support 3. An upper blade 2a is mounted on the upper blade support 2, and a lower blade 3a is mounted on the lower blade support 3. The upper blade support 2 is movable relative to the lower blade support 3. For this purpose, two hydraulic cylinders 4 are mounted in the lower blade support 3, wherein the piston rods 5 of the hydraulic cylinders 4 are connected to the upper blade support 2. By actuation of the hydraulic cylinders 4, the upper blade support 2 can be moved up and down relative to the lower blade support 3, that is, in the direction of the arrow z shown in FIG. 1.

FIG. 2 shows a side view, from the front, of the shear 1 of FIG. 1. This makes it clear that the lower blade support 3 serves as a mounting element for the two hydraulic cylinders 4. When the hydraulic cylinders 4 are actuated, the upper blade support 2 moves up and down, wherein the lower blade support 3 remains stationary and immobile in the vertical (z) direction.

When the upper blade support 2 is in the position shown in FIG. 2, a gap A is formed between the blades 2a, 3a. To cut the flat material (not shown), the upper blade support 2 is moved toward the lower blade support 3 by actuation of the hydraulic cylinders 4. The hydraulic cylinders 4 serve simultaneously as guide elements for the upper blade support 2 and are configured in such a way that they absorb not only the cutting forces which occur in the z direction but also the transverse forces, which occur in the direction in which the flat material is being conveyed. The conveying direction, in which the flat material is moved through the shear 1 and past the blades 2a, 3a, is shown in simplified form in FIG. 1 by the arrow F.

When the thickness of the flat strip or sheet material is changed, it is necessary to adjust the gap A to that thickness. This can be done by means of an eccentric bushing 6, which can be configured as a holder for a piston rod 5 of a corresponding hydraulic cylinder 4 and which is provided at the top on each side of the upper blade support 2. By turning these eccentric bushings 6, it is possible to set the distance between the upper blade support 2, i.e., the upper blade 2a mounted thereon, and the opposing lower blade support 3 to a previously determined value in the starting position of the hydraulic cylinders 4. The same applies to the angular position of the upper blade 2a relative to the lower blade 3a, that is, the angle α (compare FIG. 2), by which the longitudinal axis of the upper blade 2a is tilted relative to the lower blade 3a when the upper blade support 2 is in its starting position. This is achieved by adjusting the eccentric bushing 6 on only one side of the upper blade support 2.

When round guide elements are used, it is easy to set the cutting gap to the new value made necessary by a change in the thickness or quality of the sheet or strip by rotating the eccentric bushings 6 used as holders for the piston rods, i.e., guide rods. These eccentric bushings 6, alternatively to what is shown in the drawing, can also be arranged on the side where the forces are introduced, i.e., on the side where the hydraulic cylinders 4 are located and thus on the lower blade support 3.

As an alternative to the embodiments shown, it is also possible to provide only one adjusting device in the form of a hydraulic cylinder, which, together with its piston rod, can be mounted on, for example, the top of the upper blade support 2. By means of a suitable connecting point between the piston rod of the hydraulic cylinder and the upper blade support 2, it is possible to adjust the tilt of the upper blade support 2 to the horizontal and thus to adjust the angle α, which the longitudinal axis of the upper blade 2a assumes with respect to the lower blade 3a.

As another alternative, it is possible for the upper blade support 3 to be mounted in stationary fashion in a frame device or the like, wherein in that case the lower blade support 3 is movable relative to that. This can be done by means of hydraulic cylinders 4 in the same way as shown in FIGS. 1 and 2.

Both the upper blade support 2 and the lower blade support 3 are provided with dimensions sufficient to absorb the transverse and bending forces.

Rollers 7 are attached to the bottom of the lower blade support 3; these rollers roll along linear guides 8 in the form of rails. For the crosscutting of flat material traveling at a continuous speed, the entire shear also moves in the conveying direction F as the rollers 7 roll along the rails 8. This movement of the shear 1 occurs synchronously in time with the duration of the cutting operation, that is, synchronously with the movement of the upper blade support 2 toward the lower blade support 3. The acceleration of the shear 1 from in particular a resting starting position, the continuation of the movement of the shear 1 in synchrony with the speed of the flat strip being conveyed, and the braking after completion of the cutting operation can be realized by means of one or more hydraulic cylinders or other similarly-acting mechanical energy-storage systems, especially spring packages, which are suitably connected to the lower blade support 3 or are functionally connected to it. As explained on the basis of a hydraulic cylinder as an example, without this being considered to impose a limitation, it is obvious that the hydraulic cylinder serves simultaneously as a drive and as a braking device for the lower blade support 3. With respect to the horizontal movement of the lower blade support 3, the hydraulic cylinder is advisably arranged in a horizontal position. In addition, a hydraulic cylinder of this type can also serve as a reverse transport device, that is, as a device which moves the lower blade support 3, upon completion of a cutting operation, back to its original starting position again, so that a new cutting operation can be carried out. In this way, the hydraulic cylinder forms a single structural unit integrating the reverse transport device and the braking and/or drive device.

As an option, the shear 1 can comprise at least one clamping shoe, preferably hydraulically actuated, which can cooperate with the flat material. When the clamping shoe clamps down on the flat material, the conveying speed of the flat material is transmitted to the shear 1. As a result, it is possible to accelerate the lower blade support 3 to the conveying speed of the flat material. Under certain conditions, it is then possible to omit additional drive means for this purpose, e.g., hydraulic cylinders.

As a result of the combination according to the invention of guide and force-transmitting elements in the form of, for example, hydraulic cylinders, the structure of the shear described here is much simpler than that of a conventional shear. The stability and thus the cutting quality remain unchanged, and a nearly universal area of application is thus opened up. The more compact design of the shear makes it possible to install it in smaller work areas. Because of the smaller number of individual parts, advantages are obtained with respect to ease of installation and maintenance, and production costs are also reduced.

1-12. (canceled)

13. A shear for cutting flat material, comprising: an upper blade support; a lower blade support, wherein at least the upper blade support or the lower blade support is guided so as to move up and down; at least one adjusting device provided to move at least the upper blade support or the lower blade support relative to the opposing blade support, wherein the upper blade support and the lower blade support are connected to each other only by the adjusting device, the movable blade support is guided by the adjusting device, and the adjusting device is configured to absorb all cutting and transverse forces, wherein the adjusting device comprises exactly two hydraulic cylinders, wherein the upper blade support and the lower blade support have an elongated shape, and the hydraulic cylinders are attached to respective ends of the blade supports.

14. The shear according to claim 13, wherein one of the blade supports is configured to remain stationary in a vertical direction, wherein the adjusting device is attached to the stationary blade support.

15. The shear according to claim 13, wherein the adjusting device is attached to the movable blade support, so that, during a cutting operation, the adjusting device moves together with the movable blade support.

16. The shear according to claim 13, wherein a cutting gap between the upper blade support and the lower blade support is adjustable by an eccentric bushing or by adjustment of the adjusting device on the upper blade support or on the lower blade support.

17. The shear according to claim 13, further comprising a linear guide, the shear being movable relative to a floor along the linear guide and, beginning from a resting starting position, is acceleratable to a conveying speed by a drive device, wherein movement of the shear during a cutting operation is synchronous with a conveying speed of the flat material.

18. The shear according to claim 17, wherein the drive device is a hydraulic cylinder, a mechanical energy-storage system, and/or a clamping device.

19. The shear according to claim 18, wherein the energy-storage system includes at least one spring package.

20. The shear according to claim 18, wherein the clamping device is a hydraulic clamping shoe firmly clamped to the moving flat material.

21. The shear according to claim 17, further comprising at least one braking device provided to absorb kinetic energy of the shear to brake the shear after completion of the cutting operation.

22. The shear according to claim 21, wherein the braking device as a hydraulic cylinder or a mechanical energy-storage system.

23. The shear according to claim 22, wherein the energy-storage system includes at least one spring package.

24. The shear according to claim 21, further comprising at least one reverse transport device that returns the shear to the starting position upon completion of the cutting operation.

25. The shear according to claim 24, wherein the reverse transport device as a hydraulic cylinder or a mechanical energy-storage system.

26. The shear according to claim 25, wherein the energy-storage system includes a spring package.

27. The shear according to claim 24, wherein the braking device and the reverse transport device are integral parts of a single structural unit.
